(19) United States
(12) Patent Application Publication
(10) Pub. No.: US 2009/0077597 A1
(43) Pub. Date: Mar. 19, 2009

(54) APPARATUS AND METHOD FOR PROVIDING BROADCASTING INFORMATION IN A MOBILE COMMUNICATION SYSTEM

(75) Inventor: Mi-Sun LEE, Anyang-si (KR)

Correspondence Address: THE FARRELL LAW FIRM, P.C., 333 EARLE OVINGTON BOULEVARD, SUITE 701, UNIONDALE, NY, 11553, US

(73) Assignee: Samsung Electronics Co., Ltd., Suwon-si (KR)

(21) Appl. No.: 12/188,569

(22) Filed: Aug. 8, 2008

(30) Foreign Application Priority Data
Sep. 17, 2007 (KR) 2007-0094021

(51) Int. Cl. H04N 7/173; H04Q 7/20

(52) U.S. Cl. 725/87; 455/466

(57) ABSTRACT

An apparatus and method for providing audience information on a video service using a portable terminal are provided. The terminal includes a controller for, upon receiving an audience information request message for requesting broadcasting information including channel information on a video service and audience impressions of the video service, generating and sending an audience information message that includes the broadcasting information to a broadcasting information server.

### PRIORITY

This application claims priority under 35 U.S.C. §119(a) to a Korean Patent Application entitled “Apparatus and method for Providing Broadcasting Information in a in a Mobile Communication System” filed in the Korean Intellectual Property Office on Sep. 17, 2007 and assigned Serial No. 2007-94021, the contents of which are herein incorporated by reference.

### BACKGROUND OF THE INVENTION

1. Field of the Invention

The present invention relates generally to an apparatus and method for providing broadcasting information in a mobile communication system.

2. Description of the Related Art

In recent years, portable terminals, a necessity to modern people, have become widely used. Service providers and system manufacturers competitively develop products and services for differentiation from other enterprises.

For example, the portable terminals are evolving into multimedia equipments featuring phone books, games, short messages, electronic mail (e-mail) messages, morning wakeup calls, Motion Picture Experts Group (MPEG)-1 Audio Layer 3 (MP3) players, digital cameras, and wireless Internet services and provide a variety of services.

Further, as the recent development of a digital multimedia technology has led to an increase of the use of digital multimedia information, portable terminals supporting a function of receiving a video service (e.g., terrestrial Digital Multimedia Broadcasting (DMB), satellite DMB, etc.) and of receiving a Video On Demand (VOD)) have been developed, thus attracting much attention from users, as the video service can be used during movement.

A service provider providing such a video service collects broadcasting information such as audience ratings for a program that a terminal user views according to the user's needs. A method for collecting the broadcasting information can be divided into diary survey, interview survey, and people-meter survey methods.

In a diary survey, pamphlets are distributed to viewers of the video service, allowing the viewers to input their media exposure records in the pamphlets. The diary survey has an advantage of being cheapest compared to other surveys, but has the greatest limitations in that the diary survey depends on a human's memory. Also, the diary survey has a weak point of deteriorating the reliability of data because a representative writer inputs a record empirically, and causes an accidental error and an error of mistakenly entering a wrong channel. The diary survey has even a defective feature of relatively requiring a long time for data collection and process.

The interview survey can be subdivided into a visit survey and a telephone interview survey. The interview survey has an advantage of more reliably collecting data compared to the diary survey, but has limitations resulting from a human's memory and limitations of interviewees' non-cooperation and a higher survey cost.

The people-meter survey is evaluated as a currently most useful survey and is a method for automatically recording a media use behavior by a machine, which removes reliance upon a human's memory. The people-meter survey automatically enters and transmits a record of anyone watches any broadcasting at any moment using an electronic device attached to a television set, thus being capable of simultaneously providing both an audience pattern and population-statistic data on viewers. The people-meter survey has been adopted by more than forty-eight countries. Despite many merits, the people-meter survey still has limitations. The most representative limitations are a complicated process of installing a meter, a multitude of costs, and a demand for respondents' absolute cooperation.

In other words, a conventional broadcasting information survey has been implemented in either a direct telephone method or a collector-initiative type method obtaining only channel information on broadcasting that is now in audience by viewers. In the conventional art, a service provider has implemented the collection of broadcasting information, chiefly in a unilateral fashion. Though the viewers desire active participation, collecting audience information becomes more difficult due to unfavorable circumstances in which the viewers must accept time requirements and cost requirements.

### SUMMARY OF THE INVENTION

An aspect of the present invention is to substantially solve at least the above problems and/or disadvantages and to provide at least the advantages below. Accordingly, one aspect of the present invention is to provide an apparatus and method for providing audience information on a video service in a portable terminal.

Another aspect of the present invention is to provide an apparatus and method for providing audience information by a message service in a portable terminal.

A further aspect of the present invention is to provide a broadcasting information server for collecting audience information from a portable terminal.

The above aspects are achieved by providing an apparatus and method for providing broadcasting information in a mobile communication system.

According to one aspect of the present invention, a portable terminal for providing audience information on a video service is provided. The terminal includes a controller for, if an audience information request message of requesting broadcasting information including channel information on a video service and audience impressions of the video service is received, generating and sending, to a broadcasting information center, an audience information message that includes the broadcasting information.

According to another aspect of the present invention, a broadcasting information server for requesting audience information on a video service is provided. The server includes a server controller for sending, to a portable terminal, a request for audience information including channel information on a video service and audience impressions of the video service and, if a reply message to the request from the portable terminal is received, reading the reply message and acquiring the audience information.

According to a further aspect of the present invention, a method for providing audience information on a video service in a portable terminal is provided. The method includes acquiring broadcasting information relating to a video service received if an audience information request message of requesting broadcasting information including channel information on a video service and audience impressions of the video service, and generating and sending, to a broadcasting information server, an audience information message that includes the broadcasting information.

According to still another aspect of the present invention, a method for requesting audience information relating to a video service in a broadcasting information server is provided. The method includes generating and sending, to a portable terminal, an audience information request message of requesting broadcasting information, which includes channel information on a video service and audience impressions of the video service, and if a reply message to the audience information request message from the portable terminal is received, reading the reply message and acquiring audience information.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram illustrating a construction of a mobile communication system for providing audience information on a video service according to an exemplary embodiment of the present invention;

FIG. 2 is a flow diagram illustrating a process of providing audience information on a video service in a portable terminal according to a preferred exemplary embodiment of the present invention;

FIG. 3 is a flow diagram illustrating a process of requesting audience information on a video service in a broadcasting information server according to a preferred exemplary embodiment of the present invention; and

FIG. 4 is a ladder diagram illustrating a process of providing audience information on a video service in a mobile communication system according to a preferred exemplary embodiment of the present invention.

### DETAILED DESCRIPTION OF THE PREFERRED EMBODIMENTS

Exemplary embodiments of the present invention will be described herein below with reference to the accompanying drawings. In the following description, well-known functions or constructions are not described in detail since they would obscure the invention in unnecessary detail.

A description of an apparatus and method for providing audience information on a video service in a mobile communication system according to an exemplary embodiment of the present invention is made below. The audience information signifies broadcasting information including audience-rating information on the video service, audience impressions of a specific program, a questionnaire, etc.

The video service refers to broadcasting receivable by a portable terminal, such as Digital Multimedia Broadcasting (DMB), Digital Video Broadcasting (DVB), etc. The mobile communication system can provide the audience information using a message service.

Message services includes a Short Message Service (SMS) message, an electronic mail (e-mail), an Enhanced Message Service (EMS) message, a Multimedia Message System (MMS) message, etc. As one example, the MMS service is described in exemplary embodiments of the present invention.

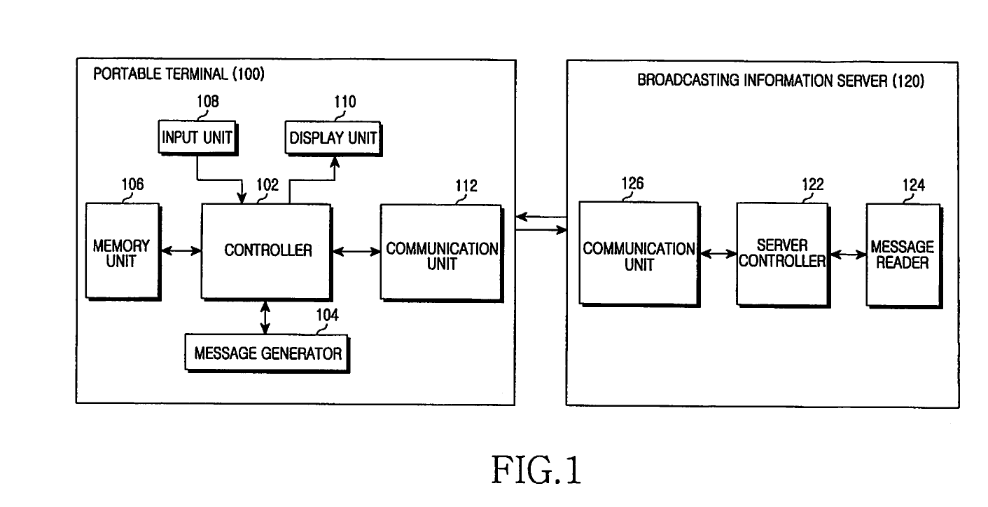

FIG. 1 is a block diagram illustrating a construction of a mobile communication system for providing audience information on a video service according to an exemplary embodiment of the present invention.

The mobile communication system according to the exemplary embodiment of the present invention includes a portable terminal 100 and a broadcasting information server 120. The portable terminal 100 refers to all terminals capable of receiving digital broadcasting, such as cellular phones, Personal Communication System (PCS) phones, Personal Digital Assistants (PDAs), International Mobile Telecommunication-2000 (IMT-2000) phones, and 4th-generation broadband system phones. The following description uses a general construction of the examples.

Referring to FIG. 1, the portable terminal 100 can include a controller 102, a message generator 104, a memory unit 106, an input unit 108, a display unit 110, and a communication unit 112.

The controller 102 controls a general operation of the portable terminal 100. For example, the controller 102 performs a process and control for voice telephony and data communication. In addition to a general function, if the portable terminal 100 receives a video information request message from the broadcasting information server 120 in the course of video service audience, the controller 102 performs a process to acquire audience information on a video service viewed by a user of the portable terminal 100, generates an audience information message including the audience information acquired from the user, and sends the audience information message to the broadcasting information server 120.

The message generator 104 generates an audience information message to be sent to the broadcasting information server 120 in accordance with instructions of the controller 102.

The memory unit 106 includes a Read Only Memory (ROM), a Random Access Memory (RAM), and a flash ROM. The ROM stores a microcode of a program for processing and controlling the controller 102 and the message generator 104. The ROM also stores a variety of reference data.

The RAM, a working memory of the controller 102, stores temporary data generated in execution of a variety of kinds of programs. The flash ROM stores a diversity of updateable safekeeping data such as a phone book, outgoing messages, and incoming messages.

The input unit 108 includes numeral key buttons ‘0’ to ‘9’, a menu button, a cancel button (delete), an OK button, a talk button, an end button, an Internet button, navigation key (or direction key) buttons, and a plurality of function keys such as a character input key. The input unit 108 provides key input data (e.g., a request for sending an audience information message, etc.) corresponding to a key pressed by a user to the controller 102.

The display unit 110 displays state information generated during operation of the portable terminal 100, a limited number of characters, a large amount of moving pictures and still pictures, the video service, etc. The display unit 110 can be a color Liquid Crystal Display (LCD).

The communication unit 112 transmits/receives and processes a radio signal of data input/output through an antenna. For example, in a transmission mode, the communication unit 112 processes original data through channel coding and spreading, converts the original data into a Radio Frequency (RF) signal, and transmits the RF signal. In a reception mode, the communication unit 112 converts a received RF signal into a baseband signal, processes the baseband signal through de-spreading and channel decoding, and restores the signal to original data. The communication unit 112 receives the digital broadcasting.

A function of the message generator 104 can be implemented by the controller 102 of the portable terminal 100. However, the separate construction shown in exemplary embodiments of the present invention is an exemplary construction for description convenience and does limit the scope of the present invention. It will be understood by those skilled in the art that various modifications of construction can be made within the scope of the present invention. For example, the controller 102 can be constructed to process all of these functions.

The broadcasting information server 120 can include a server controller 122, a message reader 124, and a communication unit 126.

The server controller 122 controls a general operation of the broadcasting information server 120. For instance, in order to collect audience information on a video service, the server controller 122 performs a process to generate and send an audience information request message to the portable terminal 100.

Upon receiving an audience information message from the portable terminal 100, the server controller 122 performs a process to allow the message reader 124 to acquire audience information included in the audience information message.

In accordance with instructions of the server controller 122, the message reader 124 reads the audience information message and acquires the audience information on the video service that includes channel information (i.e., audience-rating information) on the video service viewed by a user of the portable terminal 100 and information on audience impressions of a specific program, a questionnaire, etc.

The communication unit 126 communicates with the portable terminal 100 to send the audience information request message to the portable terminal 100 and receive the audience information from the portable terminal 100 through a reply message responsive to the audience information request message.

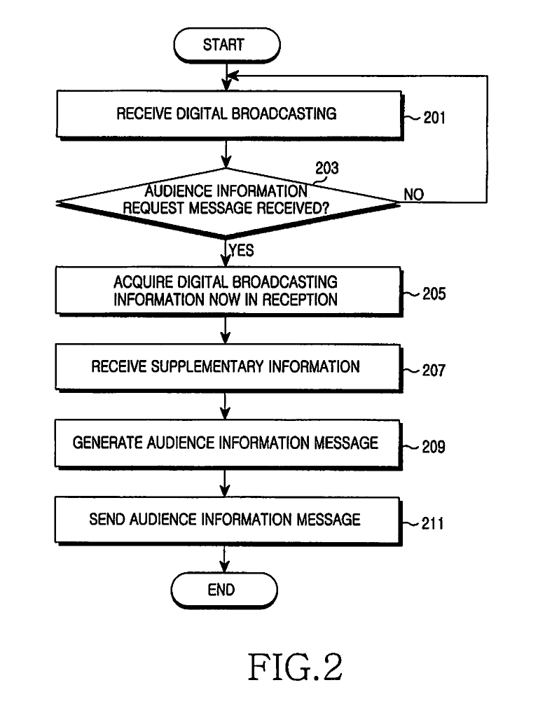

The above description is of an apparatus for providing audience information on a video service in a mobile communication system. Referring to FIG. 2, a method for providing audience information on a video service using the apparatus according to an exemplary embodiment of the present invention is described as follows.

FIG. 2 is a flow diagram illustrating a process of providing audience information on a video service in a portable terminal according to a preferable exemplary embodiment of the present invention.

Referring to FIG. 2, in step 201, a controller 102 of the portable terminal 100 receives digital broadcasting, and then determines whether the portable terminal 100 receives an audience information request message, in step 203. The audience information request message refers to a message for sending, to a user of the portable terminal 100, a request for audience information on the video service and information on audience impressions of a specific program, a questionnaire, etc.

If the portable terminal 100 does not receive an audience information request message, the controller 102 repeatedly performs the step 201.

If the portable terminal receives the audience information request message, the controller 102 acquires information on the currently received digital broadcast in step 205 and receives supplementary information from the user of the portable terminal 100 in step 207.

The digital broadcasting information is basic information on a channel of a currently-viewed broadcast, a program, etc. The supplementary information refers to information that can be directly input by the user of the portable terminal 100, such as audience impressions of a program now on the air or a specific program, a questionnaire, and an image or moving picture file obtained by capturing a picture of a the currently-viewed broadcast.

Then, the controller 102 generates an audience information message including the information in step 209 and then, sends the audience information message to the broadcasting information server 120 in step 211.

Then, the controller 102 terminates the process according to the exemplary embodiment of the present invention.

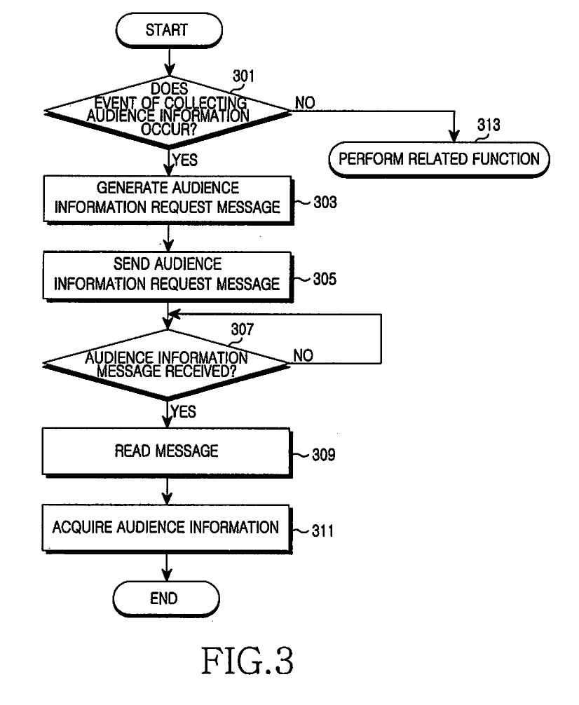

FIG. 3 is a flow diagram illustrating a process of requesting audience information on a video service in a broadcasting information server according to a preferred exemplary embodiment of the present invention.

Referring to FIG. 3, in step 301, a server controller 122 of the broadcasting information server 120 determines whether an audience information collection event occurs. If the event does not occur, the controller 122 performs a related function (e.g., an idle mode) in step 313.

If the event occurs, the controller 122 generates an audience information request message in step 303. The audience information request message is a message of capable of increasing a rate of collecting audience information on digital broadcasting by allowing a client having sent a request for an audience information message to pay a cost of the reply message.

The audience information message can include a reply-message charging field (X-Mms-Reply-Charging field), a reply-message charging identification field (X-Mms-Reply-Charging-ID field), a reply-message deadline field for storing a deadline value of the reply message (X-Mms-Reply-Charging-Deadline field), and a reply-message size field for storing a size value of the reply message (X-Mms-Reply-Charging-Size field). These fields are defined in “Open Mobile Alliance Multimedia Messaging Service Encapsulation Protocol Approved Version 1.2—1 Mar. 2005 (OMA-MMS-ENC-V1_{—}2-20050301-A)” at http://www.openmobilealliance.org.

Then, the server controller 122 sends the generated audience information request message to the portable terminal 100 in step 305. Then, in step 307, the server controller 122 determines whether the broadcasting information server 120 receives an audience information message that is a reply message responsive to the audience information request message from the portable terminal 100. If the broadcasting information server 120 does not receive the audience information message, the server controller 122 repeatedly performs step 307.

If the broadcasting information server 120 receives the audience information message, the server controller 122 reads the received audience information message in step 309, and then acquires audience information in step 311. Here, the server controller 122 can perform a process to allow the message reader 124 to read the audience information message.

Then, the server controller 122 terminates the process according to the exemplary embodiment of the present invention.

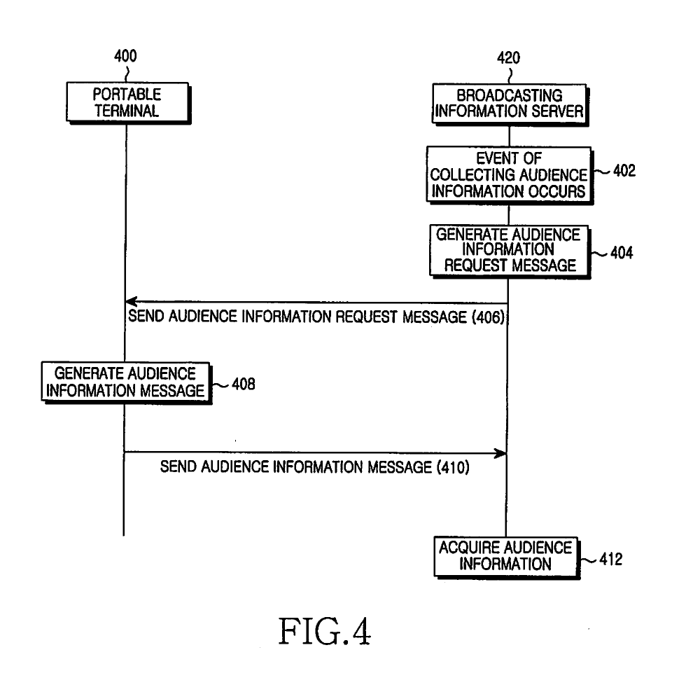

FIG. 4 is a ladder diagram illustrating a process of providing audience information on a video service in a mobile communication system according to a preferred exemplary embodiment of the present invention.

Referring to FIG. 4, the mobile communication system according to the preferred embodiment of the present invention includes a portable terminal 400 and a broadcasting information server 420.

If an event of collecting audience information on a video service for the portable terminal 400 occurs, in step 402, from a service provider providing the video service or a service provider needing the audience information on the video service, the broadcasting information server 420 generates, in step 404, and sends, in step 406, an audience information request message to the portable terminal 400.

Upon receiving the audience information request message, the portable terminal 400 generates, in step 408, an audience information message including audience information on a video service that is channel information (i.e., audience-rating information) on the video service and information on audience impressions of a specific program, a questionnaire, etc. After step 408, the portable terminal 400 sends, in step 410, the audience information message to the broadcasting information server 420.

Then, the broadcasting information server 420 reads the received audience information message, acquiring, in step 412, the audience information, i.e., the broadcasting information server 420 reads the received message, being capable of acquiring the audience information on the video service that is the channel information (i.e., audience-rating information) on the video service and the information on the audience impressions of the specific program, the questionnaire, etc.

As described above, exemplary embodiments of the present invention can positively collect audience information, by sending an audience information request message to a user of a portable terminal using a video service and receiving the audience information by a reply message responsive to the request message. Also, exemplary embodiments of the present invention impose a cost of sending the message responsive to the audience information request on a service provider that has requested the audience information, thus solving a problem in which the user of the portable terminal bears the cost.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A portable terminal for providing audience information relating to a video service, the terminal comprising:
a controller for, if an audience information request message for requesting broadcasting information comprising channel information on a video service and audience impressions of the video service is received, generating and sending, to a broadcasting information server, an audience information message that comprises the broadcasting information.

2. The terminal of claim 1, wherein the audience information is transmitted using at least any one of a Short Message Service (SMS) message, an electronic mail (e-mail), an Enhanced Message Service (EMS) message, and a Multimedia Message System (MMS) message.

3. The terminal of claim 2, wherein the audience information is provided using a message that allows a client that has sent a request for the audience information message to pay a cost of an audience information message transmitted in response to the request.

4. A broadcasting information server for requesting audience information on a video service, the server comprising:
a server controller for sending, to a portable terminal, a request for audience information comprising channel information on a video service and audience impressions of the video service and, if a reply message to the request from the portable terminal is received, reading the reply message and acquiring the audience information.

5. The server of claim 4, wherein the audience information is requested using at least any one of a Short Message Service (SMS) message, an electronic mail (e-mail), an Enhanced Message Service (EMS) message, and a Multimedia Message System (MMS) message.

6. The server of claim 5, wherein the audience information is received using a message that allows a client that has sent a request for the audience information message to pay a cost of the reply message.

7. A method for providing audience information on a video service in a portable terminal, the method comprising:
if an audience information request message for requesting broadcasting information comprising channel information on a video service and audience impressions of the video service is received, acquiring broadcasting information relating to the received video service; and
generating and sending, to a broadcasting information server, an audience information message that comprises the broadcasting information.

8. The method of claim 7, wherein the audience information is transmitted using at least any one of a Short Message Service (SMS) message, an electronic mail (e-mail), an Enhanced Message Service (EMS) message, and a Multimedia Message System (MMS) message.

9. The method of claim 8, wherein the audience information is provided using a message for allowing a client that has sent a request for the audience information message to pay a cost of the reply message.

10. A method for requesting audience information relating to a video service in a broadcasting information server, the method comprising:
generating and sending, to a portable terminal, an audience information request message of requesting broadcasting information, which comprises channel information on a video service and audience impressions of the video service; and
if a reply message to the audience information request message from the portable terminal is received, reading the reply message and acquiring audience information.

11. The method of claim 10, wherein the audience information is requested using at least any one of a Short Message Service (SMS) message, an electronic mail (e-mail), an Enhanced Message Service (EMS) message, and a Multimedia Message System (MMS) message.

12. The method of claim 11, wherein the audience information is received using a message for allowing a client having sent a request for the audience information message to pay a cost of the reply message.

13. A mobile communication system for providing audience information relating to a video service, the mobile communication system comprising:
a portable terminal for, if an audience information request message for requesting broadcasting information comprising channel information on a video service and audience impressions of the video service is received, generating and sending, to a broadcasting information server, an audience information message that comprises the broadcasting information; and
the broadcasting information server for sending, to the portable terminal, a request for audience information comprising channel information on a video service and audience impressions of the video service and, if a reply message to the request from the portable terminal is received, reading the reply message and acquiring the audience information.

14. A method for requesting audience information relating to a video service in a mobile communication system, the method comprising:
if an audience information request message for requesting broadcasting information comprising channel information on a video service and audience impressions of the video service is received, generating and sending, to a broadcasting information server, an audience information message that comprises the broadcasting information; and
sending, to the portable terminal, a request for audience information comprising channel information on a video service and audience impressions of the video service and, if a reply message to the request from the portable terminal is received, reading the reply message and acquiring the audience information.
